(19) United States
(12) Patent Application Publication
(10) Pub. No.: US 2015/0139401 A1
(43) Pub. Date: May 21, 2015

(54) METHOD OF TREATING A SURFACE LAYER OF A DEVICE CONSISTING OF ALUMINA AND RESPECTIVE DEVICE, PARTICULARLY X-RAY TUBE COMPONENT

(71) Applicant: KONINKLIJKE PHILIPS N.V., EINDHOVEN (NL)

(72) Inventors: Carolina Ribbing, Aachen (DE); Christoph Martiny, Aachen (DE)

(21) Appl. No.: 14/412,004

(22) PCT Filed: Jul. 1, 2013
(86) PCT No.: PCT/IB2013/055395

§ 371 Date: Dec. 30, 2014

Related U.S. Application Data
(60) Provisional application No. 61/669,252, filed on Jul. 9, 2012.

(51) Int. Cl. C04B 41/00; H01J 35/16

(52) U.S. Cl. CPC C04B 41/0072; H01J 35/16; C04B 41/009
USPC 378/119; 432/9

(57) ABSTRACT

A method for treating a surface layer (3) of a device (1) consisting of alumina and a corresponding device (1) are proposed. The method comprises providing the device (1) with the surface layer (3) to be treated being exposed and heating the surface layer (3) of the device (1) in an oxygen-depleted atmosphere comprising e.g. one of an inert gas, nitrogen, hydrogen, argon and a combination thereof to a temperature higher than 1000° C., preferably higher than 1700° C. for a duration of preferably more than 2 hours. Due to such treatment, a superficial layer region (7) comprised in the surface layer (3) may obtain a significantly reduced electrical resistivity which is assumed to be the result of chemically reducing this superficial layer region (7). Such reduced superficial electrical resistivity may advantageously serve for example in components of electron beam devices such as x-ray tube components for preventing any charge build-up.

### FIELD OF THE INVENTION

The present invention relates to a method of treating a surface layer of a device which consists of alumina. The invention also relates to a device comprising such conditioned surface layer consisting of alumina. In a specific embodiment, the invention relates to a component of an x-ray tube comprising an alumina surface layer.

### BACKGROUND OF THE INVENTION

There are many technical devices which completely consist of alumina (e.g. polycrystalline Al₂O₃) or at least comprise a surface layer consisting of alumina. Alumina, also referred to as aluminium oxide, is frequently used for such devices or for their surface layers due to the superior characteristics of alumina such as high electrical resistivity, high hardness, high resistance to corrosion and weathering, low density, high thermal conductivity, high melting point and excellent vacuum properties. Particularly, as alumina normally is a very good electrical insulator having an electrical bulk resistivity of approximately 10¹⁴ Ohm·cm, it is frequently used for technical devices requiring high electrical isolation.

In x-ray tubes, high electrical voltages of e.g. more than 100 kV may be applied. Accordingly, components of an x-ray tube may require high electrical resistivity and may therefore frequently consist of alumina as a base material or at least contain alumina surface layers.

Possible characteristics and properties of embodiments of the invention will subsequently be partly explained with reference to x-ray tube components. However, it shall be emphasized that, apart from such X-ray tube components, the proposed method and device may also be adapted for various other devices comprising a surface layer consisting of alumina.

In an x-ray tube, electron beams close to insulator parts may result in problems as stray electrons hitting the insulator part may cause charge build-up which can be detrimental to the electrical field and may cause deflection of the electron beam and electrical breakdown. Similar problems often arise with isolators close to tube anodes (targets), because of scattered electrons and/or secondary electrons from the anode impinging on isolator parts.

An approach to overcome such problems involves coating the surface of the insulator part with a high-resistive coating having an electrical resistivity being lower than the resistivity of the insulating material of the isolator part. Such high-resistive coating may comprise e.g. chromium oxide (CrₓO_{y} e.g. Cr₂O₃), manganese oxide (MnOₓ), silicates or various forms of carbon. Such coatings or glazings are often wet-deposited from a slurry. An alternative process is e.g. chemical vapour deposition (CVD), e.g. of chromium oxide.

However, coating a surface of an isolator part may be time consuming and work intensive, may need specific expensive deposition devices, may require additional handling efforts during device fabrication and, in a worst case, may result in insufficient properties of the deposited layer.

For example, in wet-deposited coatings, problems may occur due to pinholes or uneven deposition. The quality of coatings may be crucial for grading of a high voltage inside x-ray tubes and e.g. pinholes or thickness gradients may be disastrous.

Furthermore, isolator parts for x-ray tubes may have to be heat-treated at approximately 1000° C. to be vacuum-compatible, which may put high restrictions on matching of thermal expansion of a coating and a substrate material.

Furthermore, particularly in miniature x-ray tubes and miniature electron beam devices, wet-deposition as well as CVD may be difficult and time-consuming because of the small dimensions of such miniature x-ray tubes, of which a tube inner diameter may be e.g. smaller than 2 mm. Accordingly, for example batch processing may not be straightforward.

### SUMMARY OF THE INVENTION

There may be a need for an alternative method for treating a surface layer of a device consisting of alumina in order to modify characteristics of the surface layer such as its electrical resistivity. Particularly, there may be a need for such method for treating a surface layer requiring low device complexity, low working efforts and/or allowing modifying the surface layer of miniature devices. Also, there may be a need to implement a surface layer with a thermal expansion coefficient gradually approaching the bulk material coefficient, in order to avoid thermal stress or even layer flake- or peel-off during heat treatment or high operating temperatures.

At least some of such needs may be met with the subject-matter of the independent claims of the present application and its embodiments as defined in the dependent claims.

According to a first aspect of the present invention, a method for treating a surface layer of a device consisting of alumina is proposed, the method comprising providing the device with the surface layer to be treated being exposed, and heating the surface layer of the device in an oxygen-depleted atmosphere to a temperature higher than a lower limit temperature of at least 1000° C.

In a second aspect of the present invention, a device is proposed as it may be fabricated with the method according to the above first aspect of the invention. The device comprises a surface layer which consists of alumina and which comprises a superficial layer region and a bulk layer region. Therein, the superficial layer region has a lower electrical resistivity than the bulk layer region.

Aspects and embodiments of the present invention may be understood as being, inter alia, based on the following ideas and observations. Instead of applying a coating to a surface of a device such as an isolator part of an x-ray tube, it is proposed to directly modify a superficial layer region of the surface layer of this device in order to modify its characteristics, particularly its electrical resistivity. In other words, while the entire device or at least a part thereof forming the surface layer originally consists of alumina being an electrical insulator having a very high electrical resistivity typically in the order of magnitude of 10¹⁴ Ohm cm, it is assumed that a part of this surface layer directly at the exposed surface may be modified in its characteristics by a specific treatment procedure thereby reducing for example the electrical resistivity in such superficial layer region. For example, it is assumed that heating the surface layer of the device in an oxygen-depleted atmosphere to a temperature higher than a specific lower limit temperature of e.g. 1000° C. may result in reduction of the outermost surface of the alumina surface layer. While the effect is not yet completely proven experimentally, it is assumed that keeping the device with its surface layer exposed in an oxygen-depleted atmosphere at very high temperatures may result in the creation of oxygen vacancies Vₒ⁻ and electrons in the conduction band e_{CB}⁻, i.e. Al₂O₃→Al₂O₃₋ₓ+2e⁻ (in valence band)+Vₒ⁻+x/2 O₂

$$( i . e . {Al}_{2} {O}_{3} \to {Al}_{2} {O}_{3 - x} + {V}_{\ddot{O}} + {e}_{CB}^{-} + \frac{x}{2} {O}_{2} ) .$$

In such modified state, the alumina will have a higher electrical conductivity than the original alumina due to the electrons in the conduction band that are free to move.

Typically, the electrical conductivity in the superficial layer region resulting from the proposed surface layer treatment method may be higher by a factor of 10 to 100 than the electrical conductivity in the underlying bulk layer region of the surface layer. Due to such reduced electrical resistivity at the superficial layer region, i.e. increased electrical conductivity in such region closest to the exposed surface, charge build-up may be prevented for example during operation of an x-ray tube including stray electrons hitting the surface of the alumina part.

A concentration of an alumina compound of higher electrical conductivity and a depth of a profile can be tuned, inter alia, by gas pressure of the treatment atmosphere, temperature and treatment time. Accordingly, all these parameters may influence the local sheet resistivities within the superficial layer region.

For example, during the treatment method, the temperature may be kept above the lower limit temperature for a duration of between 1 and 24 hours, e.g. more than 2 hours or e.g. more than 5 hours.

Furthermore, depending on the electrical resistivity in the superficial layer region to be achieved and depending on the treatment duration, the lower limit temperature may be set at values higher than 1000° C. For example, the lower limit temperature may be set to 1200° C., 1500° C., 1700° C. or 1900° C. but preferably sufficiently below 2072° C. which is the melting point of alumina in order to prevent any deformations or cracks. Generally, it may be assumed that the higher the lower limit temperature is and the longer the treatment time is, the lower the electrical resistivity of the resulting superficial layer region.

It is assumed that another important feature for the proposed treatment method to be successful is that the atmosphere in which the device is held at elevated temperatures is significantly depleted from oxygen. Therein, “oxygen-depleted” may mean that the atmosphere comprises significantly less free oxygen, i.e. oxygen molecules (O₂) or oxygen ions or radicals, than normally comprised in air. For example, the oxygen-depleted atmosphere may comprise an absolute amount of oxygen being less than 10 ppm, preferably less than 5 ppm and more preferably less than 1 ppm of the oxygen content of air at 20° C. and 1000 hPa. It is assumed that the lower the content in oxygen is in the treatment atmosphere, the better the reduction result is and consequently, the lower the electrical resistivity is in the resulting superficial layer region.

One specific possibility to reduce the oxygen content in the treatment atmosphere to a minimum is to provide the oxygen-depleted atmosphere as substantially consisting of an inert gas, nitrogen, hydrogen, argon and/or a combination thereof “Substantially consisting” in this context may mean that more than 99%, preferably more than 99,9 vol-% of the oxygen-depleted atmosphere consist of the inert gas, nitrogen, hydrogen and/or a combination thereof. For example, the atmosphere may comprise 95% of nitrogen (N₂) and 5% of hydrogen (H₂).

Another option is to apply vacuum conditions during the treatment at elevated temperature, i.e. reducing the overall pressure of the gas atmosphere to a few Pa or less, e.g. to below 10 Pa, preferably below 1 Pa.

In a device having a surface layer consisting of alumina and being treated in accordance with the above described treatment method, the resulting surface layer comprises different regions, i.e. a bulk layer region consisting substantially of the original alumina and therefore having electrical resistivity e.g. in the order of magnitude of 10¹⁴ Ohm·cm and a superficial layer region which, due to the treatment, has a modified structure and/or composition resulting in a lower electrical resistivity of e.g. less than 10¹⁴ Ohm·cm, preferably less than 10¹³ Ohms. Therein, the superficial layer region may have a thickness of between 0.1 μm and 50 μm. The electrical resistivity in the superficial layer region may be decreased compared to the electrical resistivity in the bulk layer region due to chemical reduction of the alumina comprised in the superficial layer region.

Advantageously, an electrical sheet resistivity gradually increases in the superficial layer region from a lower value at an exposed surface of the surface layer towards an inner portion of the surface layer. In other words, as a result of the treatment method, a decreasing gradient in resistivity between the original alumina in the bulk and more and more of the lower-resistivity material at the surface of the device as a result of the treatment method may occur. This may relax stress due to differences in thermal expansion between the different regions and the materials comprised therein.

The proposed treatment method may be advantageously applied particularly to miniature components of an electron beam device such as an x-ray tube or an electron gun at least partly enclosing and/or at least partly facing an electron beam in the x-ray tube. Particularly, the method can be easily adopted to processing of large batches or to small parts. Especially for small tubes, the gas of the oxygen-depleted atmosphere may be conducted through the tube or filled into it only, if generation of a low resistivity superficial layer is wanted only on the inner surface of the tube.

It shall be noted that possible features and advantages of embodiments of the present invention are described herein partly with respect to the proposed treatment method and partly with respect to the proposed device. A person skilled in the art will realize that the described features may be combined or replaced by each other and may be transferred from the method to the device, and vice versa, in order to result in additional embodiments and possibly achieving synergy effects.

### BRIEF DESCRIPTION OF THE DRAWING

An embodiment of the present invention shall be described with respect to the enclosed figure. However, neither the drawing nor the description shall be interpreted as limiting the invention.

FIG. 1 illustrates a sequence of a method and features of a device according to an embodiment of the present invention.

The drawing is only schematic and not to scale.

### DETAILED DESCRIPTION OF AN EMBODIMENT

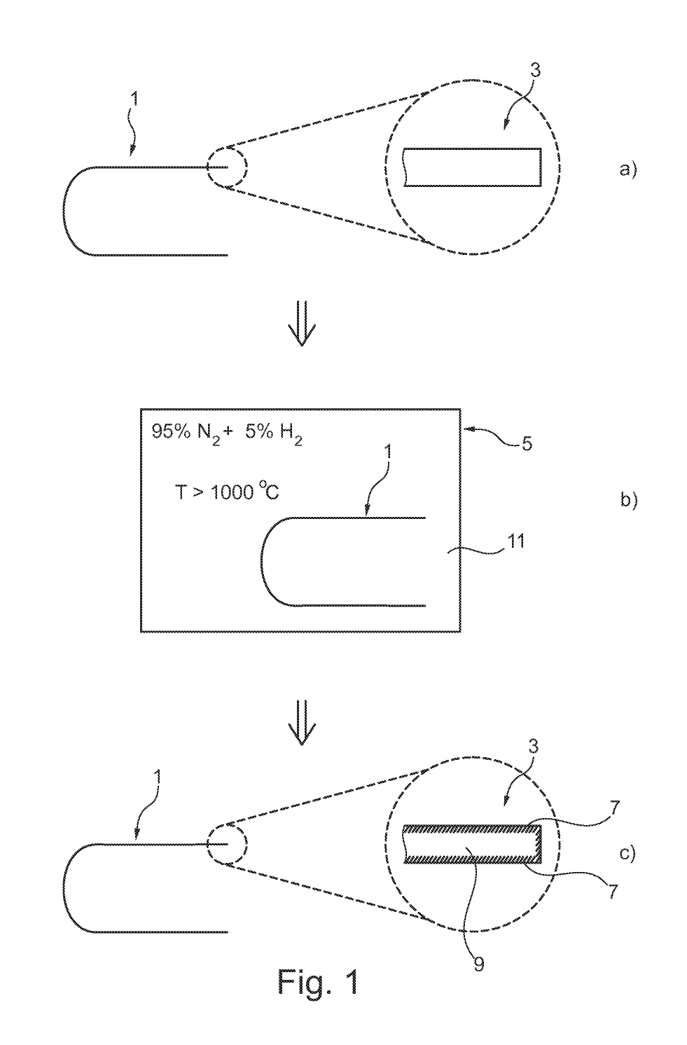

The method for treating a surface layer of a device consisting of alumina and the resulting device in accordance with an embodiment of the present invention shall be described with reference to FIG. 1.

A device 1 may have any suitable shape such as a tube, a cylinder, a slab, a bowl, etc and is provided with the surface layer 3 being exposed (FIG. 1(a)). The entire device or at least the surface layer 3 consists of alumina. The device is a component of an x-ray tube or an electron beam device which, at least partly faces an electron beam.

The device 1 is then placed into an oven 5 (FIG. 1(b)). The oven 5 is filled with an oxygen-depleted atmosphere 11 comprising 95% of nitrogen and 5% at hydrogen. Alternatively, the oven 5 may be filled with argon. The oxygen-depleted atmosphere 11 is heated to an elevated temperature of more than 1700° C. and the device 1 is kept within the oven 5 at this elevated temperature for more than 2 hours.

After such treatment (FIG. 1(c)), the surface layer 3 comprises a bulk layer region 9 in which the physical characteristics correspond to the characteristics of the original alumina material comprised in the surface layer 3 and a superficial layer region 7 in which such physical characteristics are modified due to the preceding surface layer treatment. Particularly, in the superficial layer region 7, part of the alumina material has been reduced and shows an electrical resistivity which is significantly lower than the electrical resistivity in the bulk layer region 9.

### LIST OF REFERENCE SIGNS

1 device

3 surface layer

5 oven

7 superficial layer region

9 bulk layer region

11 oxygen-depleted atmosphere

1. Method for treating a surface layer of a device consisting of alumina, the method comprising:
providing the device with the surface layer to be treated being exposed, wherein the surface layer consists of alumina;
heating the surface layer of the device in an oxygen-depleted atmosphere to a temperature higher than a lower limit temperature of at least 1000° C., thereby reducing the electrical resistivity in a superficial layer region of the surface layer.

2. Method of claim 1, further comprising keeping the temperature above the lower limit temperature for a duration of between 1 and 24 hours.

3. Method of claim 1, wherein the lower limit temperature is 1700° C.

4. Method of claim 1, wherein the oxygen-depleted atmosphere comprises an absolute amount of oxygen being less than 5 ppm of the oxygen content of air at 25° C. and 1000 hPa.

5. Method of claim 1, wherein the oxygen-depleted atmosphere substantially consists of at least one of an inert gas, nitrogen, hydrogen, argon and a combination thereof

6. Method of claim 1, wherein the pressure of the oxygen-depleted atmosphere is below 10 Pa.

7. Method of claim 1, wherein the device is a component of an x-ray tube at least partly enclosing an electron beam in the x-ray tube.

8. Device comprising a surface layer, wherein the surface layer consists of alumina and comprises a superficial layer region and a bulk layer region, wherein the superficial layer region has a higher electrical conductivity than the bulk layer region.

9. Device of claim 8, wherein the electrical resistivity in the superficial layer region is at least by a factor of 10 lower than the electrical resistivity in the bulk layer region.

10. Device of claim 8, wherein the electrical resistivity in the superficial layer region is decreased compared to the electrical resistivity in the bulk layer region due to chemical reduction of the alumina comprised in the superficial layer region.

11. Device of claim 8, wherein the superficial layer region has a thickness of between 0.1 μm and 50 μm.

12. Device of claim 8, wherein an electrical resistivity gradually increases in the superficial layer region from a lower value at an exposed surface of the surface layer towards an inner portion of the surface layer.

13. Device of claim 8, wherein the device is a component of an electron beam device at least partly enclosing an electron beam in the x-ray tube.
